(19) United States
(12) Patent Application Publication
(10) Pub. No.: US 2025/0195950 A1
(43) Pub. Date: Jun. 19, 2025

(54) System and Method for Ensuring Fairness in Virtual Golf Tournament

(71) Applicant: TRACKMAN A/S, Hørsholm (DK)

(72) Inventor: Fredrik TUXEN, Rungsted Kyst (DK)

(21) Appl. No.: 18/964,019

(22) Filed: Nov. 29, 2024

Related U.S. Application Data
(60) Provisional application No. 63/685,078, filed on Aug. 20, 2024.
(60) Provisional application No. 63/611,483, filed on Dec. 18, 2023.

(51) Int. Cl. A63B 24/00; A63B 71/06

(52) U.S. Cl. CPC A63B 24/0003; A63B 71/06

(57) ABSTRACT

A system for ensuring fairness in a virtual golf tournament includes a tournament server configured to manage the virtual golf tournament with multiple golfers playing golf on a plurality of golf simulators. The tournament server has access to a list of permitted hardware configurations for the golf simulator. Each of the golf simulator is configured to allow a playing golfer to play the virtual golf tournament. The tournament server is configured to permit participation in the virtual golf tournament from a specific golf simulator based on the hardware configuration of the specific golf simulator.

### PRIORITY CLAIM

The application claims priority to U.S. Provisional patent application Ser. No. 63/611,483 filed Dec. 18, 2023 and U.S. Provisional patent application Ser. No. 63/685,078 filed Aug. 20, 2024. The specifications of these applications are incorporated herewith by reference.

### BACKGROUND

Virtual golf tournaments generally include a number of golfers playing remotely from one another on a plurality of golf simulators. In such tournaments, data is sent from the various golf simulators to a processing arrangement (e.g., one or more server computers) controlled, for example, by an entity that is running the tournament. The processing arrangement manages the virtual golf tournament and keeps score to identify a winner or winners.

Such virtual golf tournaments in which players compete with one another from geographically separated golf simulators present many challenges which are not present in traditional golf tournaments where players play against one another on the same course. For example, the conditions in one simulator may result in different results even when two balls are struck identically. As would be understood by those skilled in the art, in simulators, the flight of the ball is interrupted after a certain distance (e.g., by contact with a screen or net) and the full trajectory of the ball is simulated based on parameters measured during this brief flight. Thus, a simulator that allows the system to track a struck ball over a greater distance before its flight is interrupted may generate more accurate data impacting the flight of the ball and thus, may more accurately calculate the path the ball would have taken under actual conditions on the course represented in the simulators.

To ensure the fairness of the competition and to enhance the players' and/or spectators' confidence in the results of these tournaments, it is important to minimize such differences. In prior tournaments concern has been expressed regarding the lack of certain tracking data on a subset of shots from some players and how the missing data may have given those players an advantage.

### SUMMARY

The present disclosure relates to a system for ensuring fairness in a virtual golf tournament. A tournament server is configured to manage the virtual golf tournament with multiple golfers playing golf on a plurality of golf simulators, the tournament server has access to a list of permitted hardware configurations for the plurality of golf simulators. Each of the plurality of golf simulators is configured to allow a playing golfer to play virtual golf. The tournament server is configured to permit participation in the virtual golf tournament from a specific golf simulator based on the hardware configuration of the specific golf simulator.

In an embodiment, the golf simulator, and the tournament server initially in a golfer-initiated tournament session run through a hardware validation process. In an embodiment, the tournament server during the hardware validation process requests hardware configuration data from the golf simulator for verification against the list of permitted hardware configurations. In an embodiment, the hardware configuration data identifies individual hardware elements of the golf simulator and firmware ensuring interoperability of the individual hardware elements of the golf simulator.

In an embodiment, the golf simulator comprises at least one launch monitor configured to track a golf ball for determining its launch parameters, and wherein the tournament server is configured to request hardware configuration data for the launch monitor. In an embodiment, the launch comprises an imager and a radar sensor device, and wherein the tournament server in a firmware validation session is configured to request firmware version data for the launch monitor for verification against the list of permitted hardware configurations.

In an embodiment, the tournament server is configured to operate as an authorization server authorizing the rights of the golfer to play golf in the virtual golf tournament.

In an embodiment, the tournament server during a tournament session is configured to receive golf data and a video stream from one of the plurality of golf simulators, the tournament server is further configured to pass the video stream to a session control server for verifying that the golfer plays according to the rules of the tournament, and wherein the session control server uses Artificial Intelligence on the video received to detect fraud or misbehavior.

In an embodiment, the session control server configured to receive a video segment of the golfer playing in the virtual environment; wherein the session control server being configured to verify that the golfer plays according to the rules of the tournament. In an embodiment, the session control server is configured to automatically control that each shot in the game play is according to the rules of the tournament. In an embodiment, the session control server is configured to use Artificial Intelligence on the video received to detect fraud or misbehavior.

In an embodiment, the session control server comprises at least one sub-program specifically trained for detecting some predefined elements in the received video segment. In an embodiment, the sub-program is specifically trained for detecting whether a golf ball is hit from within a permitted hitting area of a hitting mat. In an embodiment, the sub-program is specifically trained for visionally recognizing the clubs used by the golfer. In an embodiment, the session control server is configured, based om input from the sub-program is specifically trained for visionally recognizing the clubs, to ensure that the number of golf clubs used in the tournament does not exceed a preset limitation. In an embodiment, the sub-program is specifically trained to visionally recognize the golfer, and ensure by means of face recognition, bio-mechanical analyses, and clothing recognition to ensure that the golfer plays the entire round.

In an embodiment, the tournament server is configured to provide a sign-in procedure authenticating a golfer to sign into the virtual golf tournament; and the session control server is configured, based om input from the sub-program trained to visionally recognize the golfer, to determine that the playing golfer actually is the golfer who has been authenticated in the sign-in procedure.

In an embodiment, the sub-program is specifically trained to detect that tees are only used for shots from the tee box in the virtual golf software.

In addition, the present disclosure relates to a method for ensuring fairness in a virtual golf tournament. The method comprises managing the virtual golf tournament with multiple golfers playing virtual golf on a plurality of geographically distributed golf simulators with different hardware configurations; receiving, in a tournament server, prior to start of a tournament session data relating to hardware configuration of the golf simulator on which the tournament session is to be played; comparing the received data relating to hardware configuration of the golf simulator to a list of permitted hardware configurations for the plurality of golf simulators; and permitting participation in the virtual golf tournament from a specific golf simulator based on the hardware configuration of the specific golf simulator.

In addition, the present disclosure relates to a system for ensuring fairness in a virtual golf tournament. A tournament server is configured to manage the virtual golf tournament with multiple golfers playing on a plurality of golf simulators, each of the plurality of golf simulators configured to allow a playing golfer to play golf in a virtual environment, wherein each of the plurality of golf simulators are configured to feed launch data and video to the tournament server during a tournament session managed by the tournament server. The tournament server is configured, during a tournament session, to pass the video stream to a session control server, and wherein the session control server is configured to automatically analyze the video received for at least one predefined element for verifying that the golfer playing the tournament session plays according to the rules of the tournament.

In an embodiment, the session control server being configured to apply Artificial Intelligence on the video to verify that the golfer plays according to the rules of the tournament. In an embodiment, the session control server is configured to automatically control that each shot in the game play is according to the rules of the tournament. In an embodiment, the session control server is configured to use Artificial Intelligence on the video received to detect fraud or misbehavior.

In an embodiment, the session control server comprises at least one sub-program specifically trained for detecting the at least one predefined element in the received video segment. In an embodiment, the sub-program is specifically trained for detecting whether a golf ball is hit from within a permitted hitting area of a hitting mat. In an embodiment, the sub-program is specifically trained for visionally recognizing the clubs used by the golfer.

In an embodiment, the session control server is configured, based om input from the sub-program is specifically trained for visionally recognizing the clubs, to control that the number of golf clubs used in the tournament does not exceed a preset limitation. In an embodiment, the sub-program is specifically trained to visionally recognize the golfer, and to ensure, by means of face recognition, bio-mechanical analyses, and/or clothing recognition, that the golfer is playing the entire round.

In an embodiment, the tournament server is configured to provide a sign-in procedure authenticating a golfer to sign into the virtual golf tournament; and the session control server is configured, based om input from the tournament server and the sub-program trained to visionally recognize the golfer, to determine that the playing golfer actually is the golfer who has been authenticated in the sign-in procedure.

In an embodiment, the sub-program is specifically trained to detect that tees are only used for shots from the tee box.

In addition, the present disclosure relates to a method of ensuring fairness in a virtual golf tournament. The method comprises managing the virtual golf tournament with multiple golfers playing virtual golf on a plurality of geographically distributed golf simulators allowing playing golfers to play golf in a virtual environment, wherein each of the plurality of golf simulators are configured to feed launch data and video to the tournament server; receiving from the plurality of geographically distributed golf simulators, in a tournament server, launch data and video during tournament session; automatically analyzing the video received for at least one predefined element for verifying that the golfer playing the tournament session plays according to the rules of the tournament.

In an embodiment, the automatically analyzing of the video comprises applying Artificial Intelligence on the video to verify that the golfer plays according to the rules of the tournament.

In an embodiment, the automatically analyzing of the video comprises applying at least one sub-program specifically trained for detecting the at least one predefined element in the received video segment.

In an embodiment, the automatically analyzing of the video comprises applying at least one sub-program specifically trained for detecting whether a golf ball is hit from within a permitted hitting area of a hitting mat.

In an embodiment, the automatically analyzing of the video comprises applying at least one sub-program specifically trained for visionally recognizing the clubs used by the golfer.

In an embodiment, a session control server controls that the number of golf clubs used in the tournament does not exceed a preset limitation, based om input from the sub-program is specifically trained for visionally recognizing the clubs.

In an embodiment, the automatically analyzing of the video comprises applying at least one sub-program specifically trained to visionally recognize the golfer, and to control, by means of face recognition, bio-mechanical analyses, and/or clothing recognition, that the same golfer is playing the entire round.

In an embodiment there is provided a sign-in procedure authenticating a golfer to sign into the virtual golf tournament; and controlling by applying a sub-program trained to visionally recognize the golfer, that the playing golfer actually is the golfer who has been authenticated in the sign-in procedure.

In an embodiment, the automatically analyzing of the video comprises applying at least one sub-program specifically trained to detect that tees are only used for shots from the tee box.

In addition, the tournament system may require that all shots should be taken from the shot zone. Thus, the tournament system will receive data concerning the launch location for each shot and determine whether that location is within the shot zone. For each shot identified as launched from outside the shot zone, the tournament system may notify the player and either apply a penalty or require that the player retake the shot from within the shot zone. In some cases, depending on the tournament rules, the tournament system may disqualify a player who has taken one or more shots from outside the shot zone.

The tournament system will monitor the level of tracking based on feedback received from the various simulators and compare this to the criteria for the tournament. In one example, where all of the systems are Trackman® simulators, the tournament system may require that radar tracking OERT is enabled and/or send signals to all of the simulators automatically enabling radar tracking OERT in the settings preventing participation in the tournament without the requisite tracking level.

If, despite compliance with the rules, certain shots are still showing missing club data, the tournament system may count the shot or allow the player to retake the shot.

Prior to a tournament, the tournament system may send guidance to the players describing measures that must be taken to ensure compliance with the tournament rules. For example, the tournament system may send updated guidelines explaining how to properly configure their simulator tracking and how to identify and mark the “shot zone” on the hitting surface before play, so that players clearly know from where to launch the ball.

The tournament system might also require tournament-specific firmware or software versions to be used during the virtual golf tournament. Such tournament-specific firmware or software versions might change (to standardize) the tracking capabilities such as accuracy and pickup rate of various parameters and/or might employ different physics engines or settings. Ensuring that all players in a tournament are using the same firmware and software with similar settings is highly desirable to make an even playing field for the participants in the tournament. Such tournament specific firmware or software may also be customized to equalize results from simulators with differing hardware and tracking capabilities to further equalize the playing conditions.

The present disclosure will be described in further detail with reference to preferred aspects and the accompanying drawing.

### BRIEF DESCRIPTION OF THE DRAWINGS

FIG. 1 illustrates a system for ensuring fairness in a virtual golf tournament according to one embodiment of the disclosure.

FIG. 2 illustrates a flow chart for steps for ensuring fairness in virtual golf tournaments according to one embodiment of the disclosure.

FIG. 3 illustrates a communication scheme for ensuring fairness in the virtual golf tournament according to one embodiment of the disclosure.

FIG. 4 illustrates one first embodiment of a golf simulator for use in a system for ensuring fairness in the virtual golf tournament according to the disclosure.

FIG. 5 illustrates one second embodiment of a golf simulator for use in a system for ensuring fairness in the virtual golf tournament according to the disclosure.

### DETAILED DESCRIPTION

As indicated above, it is desired to present systems and methods that improve the quality and fairness of virtual golf tournaments. Prior systems for such tournaments have, under certain conditions, treated similarly struck balls differently due to differences in, for example, the hardware and/or software of the different simulators and/or due to the manner in which various golfers interact with the simulators.

For example, under certain conditions some club data may not be captured for a portion of shots which may result in a simulator assigning a zero-spin axis to the shot. As would be understood by those skilled in the art, this may be advantageous or disadvantageous under certain conditions.

This lack of club data can happen, for example, when a player hits from outside a permitted hitting area (i.e., a designated area within the field of view of the tracking arrangement of the simulator often delimited on a hitting mat) or when radar tracking is in a less accurate mode (e.g., when, in a Trackman® system OERT (optimized enhanced radar tracking) is not enabled in the firmware of the simulator's tracking equipment). Although missing club data resulting in zero spin axis may happen in other situations, this has currently been less common and has arisen unpredictably. The present embodiments improve the consistency with which similarly struck balls are treated among a different simulator in use by a group of geographically remote golfer (e.g., participants in a virtual golf tournament).

This is done by, for example, equalizing a level of sensitivity of the simulators' ball tracking (e.g., a sensitivity of the radar (or an optical, radar in combination with optical, or other type of tracking system) or any other qualities that impact the accuracy and level of detail of the tracking data produced by the simulators). In such a cases, a tournament system according to the present embodiments (e.g., a server or group of servers that aggregate and process data from a plurality of simulators) monitors a level of radar tracking in use by the various simulators (e.g., for each shot) to ensure, for example, that shots made when a systems' tracking level is insufficient are either retaken with the proper tracking level or otherwise dealt with (e.g., by imposing a penalty stroke, etc.). In one example in which all of the simulators are Trackman® systems, the tournament system will require OERT to be enabled for all shots by all participants so that shots made without OERT enabled will not count toward the leaderboard. In some cases, depending on the tournament rules, the tournament system may disqualify a player who has taken one or more shots with a level of radar tracking lower than that required for the tournament.

Differences in the physical and or software capabilities between the equipment of various simulators may introduce further differences into the results generated in response to identically or similarly struck balls.

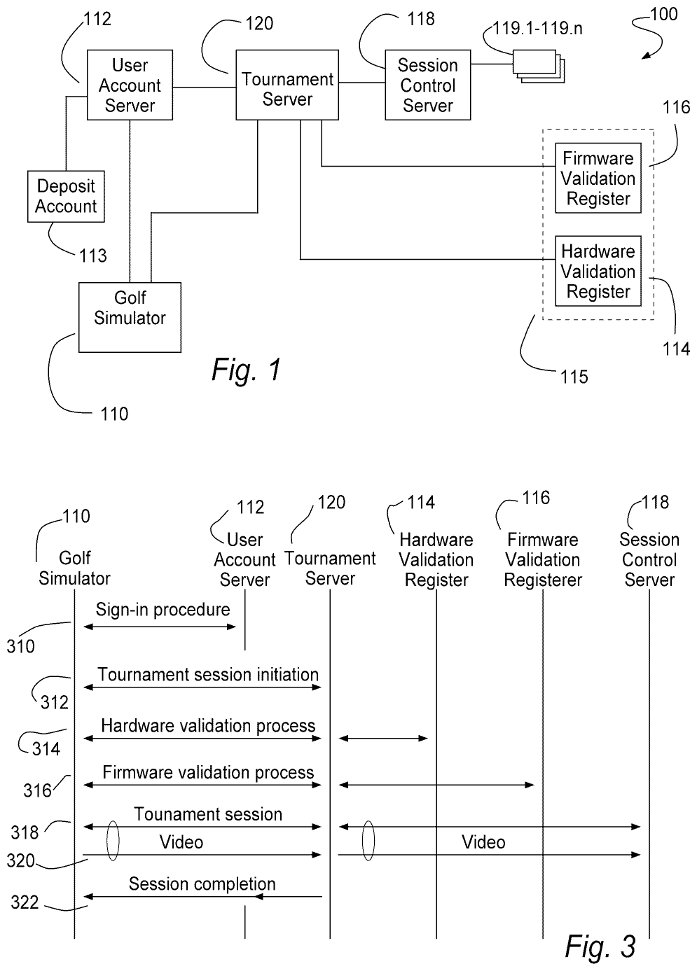

FIG. 1 illustrates a system 100 for ensuring fairness in a virtual golf tournament. When a golfer books session time on a remote golf simulator (e.g., via the internet), the golfer enters the site using a simulator 110 (e.g., a golf simulator) and identifies himself by, for example, logging into a membership account. As would be understood by those skilled in the art, the golfer login by entering credentials, such as a user ID and password. This may be done, for example, using a log-in terminal at the site with the simulator 110. In other embodiments the golfer may sign in by using a key brick with an RFID ID code uniquely identifying the golfer, or by using an app on a mobile device such as a phone. When using an app on the phone to sign in, the procedure may include any known methods such as scanning a unique bar/QR or similar code at the site with the simulator 110 so that the system 100 can link the golfer to this site.

The exemplary sign-in procedure 310 shown in FIG. 3 takes place via a secure internet connection between the user at the site with the simulator 110 and a user account server 112 acting as an authentication server for membership accounts for the tournament or for any other or entity which may be used to identify golfers who will ultimately enter a tournament. As would be understood by those skilled in the art, prior to entering credentials, the client and the server may apply cryptographic protocols, such as Secure Sockets Layer/Transport Layer Security (SSL/TLS) so that an SSL/TLS handshake is started permitting the client and the server to negotiate encryption settings and exchange keys. Once the handshake is complete, data transmitted between client and server is encrypted, enhancing the user's confidence that credentials entered necessary will not be compromised.

Once signed in at the simulator 110, the golfer's identity is confirmed or authenticated using the sign-in procedure 310. When the golfer from the simulator 110 indicates that he intends to participate in a specific virtual golf tournament, a tournament session process 312 is initiated between the simulator 110 and a tournament server 120. The tournament server 120 operates as an authorization server determining, for example, what resources or actions the golfer is allowed to access. This may also involve financial transactions such as payment of sign-up fee from the user account, and later, when the tournament has been completed, pay out of prize money.

The authentication confirms the identity of the golfer, while the authorization controls the golfer's rights based on that identity. Together, authentication and authorization ensure secure and controlled access to the tournament services. Once authenticated, the golfer can move on.

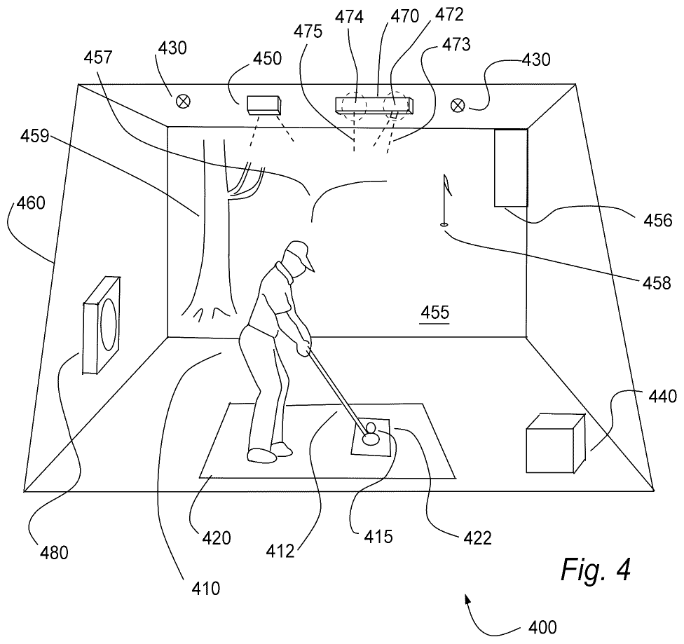

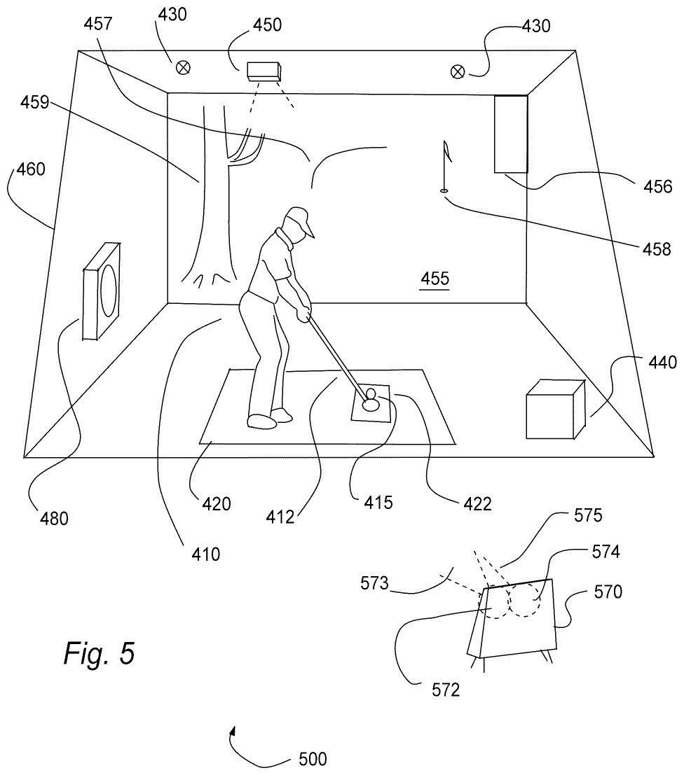

To ensure fairness in the virtual golf tournament, the tournament server 120 according to this embodiment is configured to manage the virtual golf tournament with multiple golfers playing on a plurality of geographically distributed golf tournament simulators 110. The tournament server 120 has access to a list of hardware and software configurations permitted for use in the tournament and can apply these to information received from the various simulators 110 to determine eligibility of all of the tournament entrants. In this embodiment, each of the simulators 110 comprises a launch monitor 470, 570 (FIGS. 4 and 5) configured to track the swing of the golf club 412 prior to impact and to track the golf ball 415 after impact although, as would be understood by those skilled in the art, the swing of the golf club 412 may also be tracked after the impact of the golf club 412 and the golf ball 415. In this example, the golf ball 415 and the golf club 412 are tracked using a radar 474, 574 and/or a high-speed camera or imager 472, 572. However, as those skilled in the art will understand, any other types of golf ball tracking system may be employed so long as the system hardware and software are compatible with the tournament rules.

In one embodiment, prior to the tournament, the organizer of the tournament may have tested various launch monitors in relation to a reference launch monitor to generate the tournament hardware/software rules. The test may include, for example, a plurality of different golf shot shots monitored by the reference launch monitor and the launch monitor being tested so that the output for the golf shots can be compared to determine, for each tested launch monitor, whether the output falls within a set of predefined tolerances as compared to the output from the reference launch monitor. The organizer of the tournament may, for example, approve for use in the simulators 110 using launch monitors having qualities (e.g., hardware and software matching key specifications as will be described below) the same as the tested launch monitors that have achieved a desired level of performance in comparison to the reference launch monitor.

This approval may specify the permitted hardware by name, e.g., Trackman® and/or model (e.g., Trackman 4) as well as any firmware/software settings or updates shown to have been necessary to achieve the desired level of performance. Furthermore, the launch monitor 470, 570 may during its lifetime be manufactured in different versions, where the later version e.g., version 2.0 and later, may have an improved imager 472, 572 (e.g., a camera) or an improved processor for the ball tracking calculations. Therefore, the approval of the launch monitor hardware may be limited to certain versions of the hardware of the launch monitor, e.g., version 2.0 and later.

Finally, firmware is a type of software that plays a crucial role in the operation of hardware devices. Firmware is embedded directly into a piece of hardware to ensure it functions as intended. It acts as a bridge between the hardware and the operating system, providing low-level control over the device's components. Firmware generally resides in non-volatile memory, which can be, for example, either read-only memory (ROM) or programmable memory, such as EPROM, EEPROM, or flash memory. Changing firmware stored in ROM generally requires physical replacement of the memory chip, while programmable firmware memory can often be reprogrammed through a process known as flashing. Launch monitors are often updated with firmware distributed over the internet. When booted a golf simulator or a launch monitor connected to the internet may look for firmware updates available. E.g., Trackman® uses firmware to ensure that the optically enhanced radar tracking (OERT) technology to capture a precise impact location on the clubface operates as intended.

The organizer of the tournament may then store a list of approved launch monitors 470, 570, e.g. restricted to certain versions or models thereof, in a hardware validation register 114 along with requirements regarding specific versions of software, firmware, (e.g., Firmware Version 2.7.3 or later), and other hardware required for each permitted launch monitor 470, 570. This list of permitted firmware for the permitted hardware may be stored in a firmware validation register 116. The hardware validation register 114 and the firmware validation register 116 together provide a database 115 for all permitted hardware configurations. The database 115 may in one embodiment be stored in a part of the tournament server 120. In another embodiment, the database 115 may be present on a separate server, e.g., cloud based, and be accessible by the tournament server 120 through any known data connection.

When a golfer user applies to enter the tournament, a hardware validation process 314 is started by the tournament server 120 requesting that the simulator 110 identified by the golfer as the simulator 110 he will use in the tournament identify selected predetermined hardware components necessary to ensure that the simulator 110 meets the tournament requirements. These predetermined hardware components may include, for example, details concerning the construction and operation of the simulator 110 including details concerning the radar 474, 574, an imager 472, 572 (e.g., a high-speed camera), the processor of the launch monitor 470, 570 as well as details concerning available memory of the launch monitor 470, 570 and manufacturing details for these components (e.g., serial numbers or other identifiers) that can be used to verify the compliance of the simulator 110 to the tournament requirements.

In some embodiments, the launch monitor 470, 570 is handled as one unit, so the response will include the launch monitor hardware ID and version number. These data are normally hardcoded into a memory component (e.g., a ROM). From the serial number, it is often possible to identify hardware types, hardware versions and manufacturing dates, etc. The hardware validation process 314 in this embodiment includes comparing data for the predetermined hardware components to data stored in the hardware validation register 114.

The hardware validation process 314 may also include a request to the launch monitor 470, 570 to indicate whether the radar 474, 574 and a high-speed camera or imager 472, 572 have been calibrated in its current set up and/or to request data from the launch monitor 470, 570 enabling the tournament server 120 to determine whether any such a calibration remains valid. In some embodiments additional equipment, such as extra cameras, e.g., a mobile phone having a predetermined app, may be part of the hardware validation process 314. This additional equipment may provide enhanced video coverage for the virtual golf scene. To the extent such additional equipment was identified by a golfer as part of the simulator 110, all of this additional equipment would need to be approved by the tournament server 120 (e.g., either separately or in conjunction with the specific software and hardware of the launch monitor 470, 570) in the same manner.

Once the hardware validation process 314 has been successfully completed, a firmware validation process 316 is started by the tournament server 120 which sends a request to the simulator 110 asking that the simulator 110 provide identify data concerning enabling the tournament server 120 to determine if the firmware components meet the tournament criteria. In this embodiment, this will mainly be to check whether the firmware of, e.g., the launch monitor, is updated to a required level to ensure that the performance of the launch monitor 470, 570 corresponds to what has been approved for use in the virtual golf tournament to ensure fairness for all players. If the firmware validation process 316 fails, the user, or the simulator 110 may, for example, be requested to update the firmware of the launch monitor 470, 570. If successful, the tournament server 120 deems the launch monitor 470, 570 to have a permitted hardware/software configuration, and the golfer is permitted by the tournament server 120 to start the actual, virtual golf tournament.

If the hardware validation process 314 fails, or the golfer is not able to update the firmware to a permitted firmware version, the golfer is notified. In some embodiments, the tournament server 120 may inform the golfer about simulators 110 in the neighborhood that have passed the hardware validation process 314 and the firmware validation process 316 and are assumed to have a permitted hardware/software configuration.

The golfer may then start playing the Virtual Golf Tournament in the tournament session 318. During the tournament session 318, the golfer will in this embodiment play a golf course (e.g., a stroke play game) identified by the tournament server 120 and managed by the simulator 110. During the tournament session 318, the simulator 110 tracks each shot and calculates ball data for each hole for each golfer. In one embodiment, these data are uploaded to the tournament server 120 after each shot. In another embodiment, the ball data is uploaded after each completed hole. During the tournament session 318 of this embodiment, the launch monitor 470, 570 (as well as any additional cameras) is configured to capture video sequences and stream these captured video sequences to the tournament server 120.

In some embodiments, the launch monitor 470, 570 may generate a message warning about the validity of generated launch data for a particular shot. This warning message may be a simple e.g. two-digit code, where a first number indicates one problem with the shot (e.g., that the ball was not visible at the time of impact while a second number indicates a second issue (e.g., that spin of the ball could not be sensed or not sensed with a desired degree of confidence), and so on. The code may cause the tournament server 120 to transmit to the golfer instructions indicating how the golfer is to proceed in view of the specific detected issue and/or any history of earlier issues.

Video streaming 320 over the Internet generally involves breaking down (encoding and packetizing) audio and video data into a series of smaller packets. These packets are then transmitted from the simulator 110 to the tournament server 120 where the data packets are decoded to generate the streamed video and/or audio. The ball data may also be integrated into the transmitted data packets. In addition, the warning message generated by the launch monitor 470, 570 may be included as packet data, e.g., as a part of the ball data for an individual shot, which is sent to the tournament server 120. In one embodiment, a header attached to each of the data packets informs a decoder at the tournament server 120 about the content and order of the data packet. In one embodiment, the ball data is handled as metadata. In one embodiment, the generated streamed video is output with captured video in one part of the screen and the ball data in another part. In one embodiment the data is presented in a split screen and in another embodiment, ball data is presented in a minor field of the screen.

The tournament server 120 forwards the generated streamed video and the calculated ball data to a session control server 118 that analyses this data to verify that each of the golfers plays according to the rules of the tournament. The session control server 118 automatically determines whether each shot is taken in accord with the rules. The session control server 118 receives the video of the golf stroke, the launch parameters for the ball, and error message from the launch monitor 470, 570 if given. The session control server 118 uses Artificial Intelligence on the video received to detect fraud or misbehavior and the session control server 118 then generates an indication of any detected issues for use by the tournament server 120 in correcting errors and/or taking action to prevent further errors or to prevent other prohibited shots from being counted in the tournament.

The tournament server 120 may also, based on the information from the session control server 118, take any other actions necessary to preserve the integrity of the tournament. For example, as indicated above, golf shots launched from outside the permitted hitting area 422 may not be counted, and the golfer 410 may be required to replay any such shot. In some embodiments, the golfer 410 may get a warning when the golfer 410 launches a second shot from outside the permitted hitting area 422. The golfer 410 may even receive penalty points added to his overall score, or he may have to replay the round. Under certain conditions, the golfer 410 may even be disqualified from the tournament.

For this purpose, the session control server 118 has several sub-programs 119.1-119.n including one specifically trained for detecting for each shot whether the ball has been hit from within a permitted hitting area 422 (e.g., within a prescribed portion of a hitting mat 420). One of the sub-programs 119.1-119.n may also be specifically trained to visually recognize the clubs used by the golfer 410 to, for example, ensure that the number of golf clubs used in the tournament by the golfer 410 does not exceed a preset limitation or to ensure that any particular club does not violate any other rule of the tournament. Another of the sub-programs 119.1-119.n may also be specifically trained to visually recognize the golfer 410 (e.g. by means of face recognition, bio-mechanical analyses, and/or clothing recognition) to ensure to a high degree of certainty that the golfer 410 playing the entire round actually is the golfer who has been authorized and authenticated during the sign-in procedure 310.

Additional ones of the sub-programs 119.1-119.n may be configured to ensure that other rules are followed (e.g., to ensure that tees are used only for shots from the tee box) while others of the sub-programs 119.1-119.n may be used to detect any changes to the simulator environment during the round (e.g., including a tee area, lighting conditions, the inclusion of forbidden alignment aids, etc.). A further one of the sub-programs 119.1-119.n may also be used to verify that the session is played in the correct order and at a required speed (e.g., completed in a continuous session within set timing restraints).

The session control server 118 evaluates each stroke played and the video received by the sub-programs 119.1-119.n, the ball data received from the launch monitor 470, 570, and any error messages sent by the launch monitor 470, 570 to detect any indications of error or fraud. If no such issues are detected, the shot is accepted and added to the tournament score for the golfer 410. However, if the session control server 118 detects something suspicious or impermissible in the data analyzed, the shot may be rejected. Depending on the reason for the rejection, the golfer 410 may be asked to re-take the shot, have one or more penalty points added to his score, be disqualified or incur any other penalty or requirement required by the tournament rules. The session control server 118 provides feedback for each shot to the tournament server 120, and also to the simulator 110 within, for example, approx. 10-15 seconds from the shot has been taken.

According to one aspect of the disclosure, one or all of the sub-programs 119.1-119.n may use one or more object detector generated using Artificial Intelligence. Various types of object detectors of varying complexity may be used according to the present embodiments. Object detectors such as, e.g., YoloV3 or Faster-RCNN, are commonly used within computer vision and/or AI/deep learning applications. As would be understood by those skilled in the art, object detectors can be designed by those skilled in the art to detect particular types of objects for which the object detector has been trained (e.g., with training data having detailed annotations). The object detectors can either be created from scratch or by retraining already available models.

FIG. 4 illustrates one example of a simulator 400 (e.g., a golf tournament simulator). The simulator 400 is an advanced system that allows a golfer 410 to practice and play golf in a virtual environment. The simulator 400 comprises a simulator computer 440 or a simulator processor controlling the data capturing and the virtual golf experience for the golfer 410. The golfer 410 stands on a hitting mat 420 when hitting a golf ball 415 with a golf club 412. The hitting mat 420 defines a permitted hitting area 422. The hitting mat 420 is generally an essential part of such a setup as it provides a surface that allows the golfer 410 to swing the golf club 412 as if he was playing on a real golf course.

The hitting mat 420 may have a surface that mimics the feel of real grass and allows the golfer 410 to hit shots including two or more separated areas mimicking different surface types found on golf courses. Then, depending on where on the simulated golf course the simulator 400 determined that the previous shot of the golfer 410 came to rest, the simulator 400 will indicate from which of the areas of the hitting mat 420 the golfer 410 is the permitted hitting area 422 from which the golfer 410 is required to take his next shot. shot. A plurality of light sources 430 are arranged (e.g., in a ceiling) for providing appropriate lighting conditions permitting the data capturing sensors to capture the data required to calculate the parameters necessary to accurately simulate each of the shots of the golfer 410.

In one embodiment, one of the light sources 430 is directional and is configured to illuminate an area on the hitting mat 420 and thereby define the permitted hitting area 422 for the next shot of the golfer 410. In a further embodiment, a mask is provided in front of the light source 430 so that illumination is limited to the permitted hitting area 422 on the hitting mat 420. By displacing the mask, the illuminated permitted hitting area 422 on the hitting mat 420 may be shifted to another of the different surface types on the hitting mat 420 in accord with the results of the previous shot of the golfer 410. The simulator computer 440 controls the light source 430 illuminating the permitted hitting area 422 on the hitting mat 420 by aiming at the light source 430 or by displacing the mask and thereby indicates the position of the permitted hitting area 422 to be used for the current shot.

In one embodiment, the hitting mat 420 is slightly raised above the floor on which it is resting. Then, the hitting mat 420 may have actuators in the corners permitting the simulator 400 to adjust a slope of the hitting mat 420 to simulate the conditions on the portion of ground of the simulated golf course on which the previous shot of the golfer 410 came to rest. These actuators and thereby the slope of the hitting mat 420 are controlled in this embodiment by the simulator computer 440.

The simulator 400 illustrated in FIG. 4 includes a launch monitor 470 which, in this embodiment, is a ceiling mounted launch monitor such as a Trackman® iO. Various features of launch monitors such as the Trackman® iO have been described by the applicant in U.S. patent application Ser. Nos. 18/334,730, 18/334,685, and 18/334,764 all filed Jun. 14, 2023 and in U.S. Provisional patent application Ser. No. 63/623,509 filed Jan. 22, 2024. The above identified applications are hereby incorporated by reference in their entireties. The launch monitor 470 is configured to capture data about the swing of the golf club 412, the impact between the golf club 412 and the golf ball 415, and the launch parameters for golf ball 415. The captured data is, in one embodiment, handed over to the simulator computer 440 which has been configured to use this data to determine critical ball and club data.

As would be understood by those skilled in the art, club data parameters useful in these embodiments may include, for example, any or all of club speed, attack angle, dynamic loft, face angle, club path, face to path, impact height, impact offset, smash factor, and dynamic loft while ball data parameters useful in these embodiments may include, for example, any or all of ball speed, launch angle, launch direction, spin rate, spin axis, hang time, height, curve, landing angle, carry, side, total, and side total.

Traditionally two types of tracking technologies have been used in these simulators-doppler radar technology tracking and high-speed camera-based tracking along with systems that use both of these technologies in a cooperative manner. The launch monitor 470 of this embodiment includes an imager 472 (e.g., a high-speed camera) having a field of view 473, and the radar 474 having a main axis 475. By combining data from these two systems, detailed and accurate club data, launch parameters, and ball flight data is obtainable.

The technology combining radar data and camera data is called Optically Enhanced Radar Tracking (OERT) by the applicant and is used to provide state-of-the-art accuracy in tracking club movement and ball flight by the applicant's golf launch monitors 470. OERT captures a more precise impact location on the clubface. For example, the radar 254 may include a 24 GHz ultra-low-power radar which may be used to achieve accurate speed and distance measurements while the imager 472 may provide superior angular data and directly measured 3D spin. The combination of data from these sources permits a high level of accuracy for all of the parameters necessary to accurately simulate golf shots.

As mentioned above, golf simulators such as the simulator 400 generally include a structure 460 such as a cage, an impact screen or a mesh net to keep the ball contained and prevent it from flying off or ricocheting back into the room. The impact screen absorbs the ball's impact, while a mesh net catches it. The cage-like structure 460 of this embodiment includes an impact screen that also serves as a projector surface 455 on which the virtual golf game is visually presented to the golfer 410.

In some embodiments, the simulator 400 comprises a sound system 480 simulating the sounds of a golf course, such as birds chirping or the wind rustling through trees.

A high-resolution projector 450 is arranged (e.g., in the ceiling of the cage-like structure 460) for displaying the virtual golf course and the surrounding environment). It provides realistic graphics allowing the golfer 410 to see where his shots land. The high-resolution projector 450 presents the virtual golf game on the projector surface 455. The presented virtual golf game indicates a target 458 for the golfer 410 as well as various obstacles and hazards like trees 459, bunkers, and water features and may also indicate a border 457 between fairway and rough. A part of the projector surface 455 may also display a mini-map 456 of all or any part of the golf course being simulated.

The mini-map 456 may present various tools assisting the golfer 410. For example, one of the tools may present a bird's-eye animation (fly over) of the hole layout prior to start. A second tool permits a golfer 410 to zoom into the green so that the details of the green topography are visible to the golfer 410. These tools permit the golfer 410 to read slopes and breaks on the green to gauge distances to trees, bunkers, and hazards, etc., in a manner similar to what the golfer 410 might expect when playing a real course. After each stroke, the data determined by simulator computer 440 may be presented in either the mini map area or overlaid on the virtual graphics presented on the projector surface 455 as would be understood by those skilled in the art.

The determined parameters are used by the simulator computer 440 as input to mathematical models for the ball in flight and for the balls interaction with the ground to determine an end position for the golf ball 415. This data originating from the launch monitor 470 is used as input to the simulator software running on the simulator computer 440. The simulator software is configured to simulate different golf courses, weather conditions, and ball flights. The software may provide accurate renditions of the courses on the screen. The golfer 410 may play virtual rounds and experience playing on different courses without leaving the simulator setup. Finally, by connecting the simulator computer 440, the simulator 400 allows the golfer 410 to compete against other golfers virtually.

As would be understood by those skilled in the art, the simulator 400 combines hardware (sensors, screens, and projectors) with powerful software to create a lifelike golf experience indoors permitting a golfer 410, when not playing in a tournament, to fine tune his swing or to play a virtual round regardless of weather or location. FIG. 5 illustrates a second embodiment of a simulator 500 for use in a system for ensuring fairness in virtual golf tournament according to the disclosure. Here the ceiling mounted launch monitor 470 is replaced by a launch monitor 570 configured to rest on the floor behind the golfer 410 when taking shots. Trackman® 4 is an example of a transportable launch monitor that may serve as the launch monitor 570 which may be connected to the simulator computer 440 in any known manner (e.g., wirelessly or through a wired connection). Trackman® 4 comprises a Dual Radar system (e.g., 10 GHz and 24 GHZ), and is synchronized in time and space. The Dual Radar system transportable launch monitor 570 provides a short range, ultra high-resolution system focused on putting as well as a system accurately determining club and impact data enabling long range, high accuracy ball tracking.

The launch monitor 570 includes a high speed camera or imager 572 having a field of view 573, and a radar 574 having a main axis 575. By combining data from these two systems, a desired level of detail and accuracy in measuring club data, launch parameters, and ball flight is obtainable. Optically Enhanced Radar Tracking or any other suitable tracking may be employed to capture the impact location on the clubface. The simulator 500 is substantially similar to the simulator 400 apart from the replacement of the ceiling mounted launch monitor 470 by a launch monitor 570 configured to rest on the floor behind the golfer 410. The remaining components of the two simulators 400 and 500 are the same, and these remaining components will not be discussed further.

Golfers around the world already play virtual golf indoor on simulators informally (e.g., to keep their skills sharp during the off-season) while Next Golf Tour, www.nextgolftour.com, provides a virtual golf tournament in which the players plays against each other on Trackman® simulators.

The system according to the present disclosure provides a platform for ensuring fairness in a virtual golf tournament. In one embodiment, a tournament setup at each virtual course will be made available only for registered entrants. Once registered, the entrants may, for example, complete their tournament round at any time during a so-called event window. In one embodiment, the tournament round must be performed while streaming or recording a video stream 320 of the tournament strokes during the tournament session 318. In on example, enrolment to participate in a tournament involves payment of an entry fee. Elite player tournaments may have prize money for the winner and the runners up. As would be understood by those skilled in the art, off-season virtual golf tournaments may permit elite players to earn income and develop their brands and may serve as a supplement to established pro golf tours. Furthermore, virtual golf tournaments that capture the interest and which are perceived as fair by the public can enhance the interest of the public in golf simulators generally while encouraging serious competition, entertainment, and fan engagement.

An exemplary tournament format may involve, for example, six individual 18-hole individual stroke play sessions followed by a 36-hole season finale session. In one embodiment, there is a due date for signing up to participate in one or more of the individual stroke play sessions of the virtual golf tournament. In one embodiment, the golfers may attend all the individual stroke play sessions once they have signed up. In other embodiments, a golfer must sign up for each individual stroke play session in which he would like to participate, and each of the individual stroke play sessions may also have individual sign-up windows, e.g., immediately before an individual stroke play session is planned to take place. As would be understood by those skilled in the art, participation in the individual stroke play sessions of the virtual golf tournament may require payment of a sign-up fee.

The system according to the disclosure ensures fairness in a virtual golf tournament by validating the hardware of the simulator 400 and ensuring that the golfer 410 is playing according to the rules of the tournament. The number of the simulators 400 to be included in a virtual tournament is highly scalable. For example, for a tournament in which a timeslot of e.g., 2 weeks is allotted for completing participation in a stroke play session, and with the simulators 400 available throughout the world, a significant number of golfers may attend the individual stroke play sessions and play to try to earn prize money and/or to qualify for one or more additional tournaments such as, for example, a season finale. In some embodiments, a tournament may define a maximum number of participating golfers and in other embodiments, a tournament may require that, to participate, a golfer must have a certain handicap, e.g., below 5 or 10. In other embodiments, the golfers may be divided into leagues according to their handicap, so that golfers may compete globally against players at a similar skill level.

Several thousands of public golf simulator venues exist today throughout the world, and a high number of golf simulators have been installed privately. The public golf simulator venues existing today include indoor golf simulators in golf clubs, entertainment centers, and bars, etc. In one embodiment, to participate in a tournament using a public golf simulator, a golfer 410 must book a timeslot. Each event may be played in the same manner as a traditional outdoor tournament and similar rules of golf may apply for the virtual golf tournament. According to these rules, as indicated above the golfer 410 may, for example, be permitted to start the tournament event or round only with a certain number of golf clubs 412 (e.g., max fourteen golf clubs 412).

Furthermore, as indicated above tees may only be used for shots from the tee box. Furthermore, as stated above the tournament rules may require that no changes be made to the playing environment during the round (e.g., including the tee area, lighting, alignment aids, etc.). Furthermore, as indicated above the entire golf scene may be required to remain visible from the launch monitor throughout the round. In this case, for example, non-transparent obstacles that would hide parts of the golf scene may need to be removed before starting play. As indicated above, to enable the simulator 110, 400, 500 to properly determine the golf shot properties, the golf shot must be hit from within the permitted hitting area 422.

If the simulator 110, 400, 500 is not configured to mark a permitted hitting area 422 on the floor (e.g., using lighting as described above), the tournament rules may require that the golfer 410 mark the permitted hitting area 422 himself (e.g., as a rectangle having specified dimensions in some manner such as by using adhesive tape or dots), and to ensure that the launch monitor 470 is calibrated to the permitted hitting area 422. If the launch monitor 470 is bumped or repositioned, re-marking the permitted hitting area 422 or recalibration of the launch monitor 470 may be required.

Based on data collected by the session control server 118, a subset of the golfers (e.g., those with the best scores in the tournament) may be subject to a manual post round validation process to confirm the identity of the golfer as well as to confirm that all shots were hit from with the permitted hitting area 422 and that other rules of the tournament have been complied.

In some tournaments, alignment aids such as an alignment stick or tape on the floor may not be permitted. The sessions control server 118 in such a case will be configured to automatically monitor to determine whether this rule has been not violated (e.g., by using pattern recognition to detect any illegal patterns within or adjacent to the permitted hitting area 422). The sessions control server 118 may then take any of a number of predetermined actions in response to a violation of this (or any rule). For example, a sanction for a first breach may be a two-stroke penalty, while a second breach may cause disqualification.

All golfers 410 in the tournament will have the validity of their delivered strokes verified automatically by the session control server 118 based on the received video stream 320 streamed, for example, in real-time from the simulator 110, 400, 500. The session control server 118 will check the video stream 320 for each player to detect any of a predefined number of indicators of impermissible actions and, when suspicious activity or a potential breach of any of the rules is detected, the session control server 118 may automatically take enforcement action or, under predefined conditions, may provide an alert to the tournament server (or tournament personnel) and may also provide notice to the simulator 110, 400, 500 used by the effected golfer 410. The session control server 118 may identify to tournament personnel parts of the video stream 320 relevant to a suspected rules infraction for manual review based on captured ball or club parameters or detected visual elements. For golfers 410 who are candidates for monetary prizes, a tournament umpire panel may afterward manually review the relevant portions of the video stream 320 or potentially suspect parts thereof.

The season long ranking is based on the money prize earned, the Order of Merit. In some embodiments, there is a special trophy for the Order of Merit winner. As a tournament is played on individual simulators 110, 400, 500, side games may, for example, be played in addition to the stroke play or any other main tournament format. These side games (e.g., “closest to the pin”, “longest drive”, or “birdie streak”) may also be verified automatically by the session control server 118 and, optionally, manually reviewed by a tournament umpire panel (e.g., via the video stream 320 or selected parts thereof identified by the session control server 118). In some embodiments, the side game rankings may also result in money prize earnings affecting the Order of Merit.

A tournament may, as a part of the sign-up procedure, require participants to give the tournament the right to use video content, stills, etc. on social media and for marketing purpose, and may automatically generate video clips of interest (e.g., for participants in and fans of the tournament). The auto generated clips may be companioned by data about the golfer 410 derived from, for example, a player profile, data about a specific golf shot picked by the launch monitor 470, 570 and uploaded to the tournament server 120, and data about a current score or ranking of the golfer 410 managed by the tournament server 120.

In one embodiment, the user account server 112 may be configured to manage a deposit account 113 for one or more of the golfers 410, e.g., to receive sign up fees and/or to distribute prize money and this may be managed by the tournament server 120. This type of financial instrument makes it convenient for the golfer to deposit and withdraw money in relation to his participation in golf tournaments, such as the Virtual Golf Tournament according to the present disclosure. Payout of prize money won will automatically enter the balance of the deposit account 113. The money is available for withdrawal at any time, making them suitable for day-to-day transactions, such as payment for signing up to new tournaments or withdrawal of money to the golfer's bank account. Then golf player may pay the sign-up fee for his participation in the individual stroke play session via this deposit account 113. Transfers to and from the deposit account 113 may be made, for example, via a bank account transfer, using a credit card, Paypal®, Apple Pay®, or the like.

In some embodiments, the golfer 410 will be notified about movements on his deposit account 113 via an app on his mobile phone or another device (e.g., the device used by the golfer 410 to sign up for a tournament.

In one embodiment, the simulator 110 and tournament server 120 ensure that the performance of the golfer 410 is documented by a real-time video stream 320 to the session control server 118. In some embodiments, the session control server 118 may receive the video stream 320 via an upload from the simulator 110 to the tournament server 120 based on instructions from an app on a mobile phone or other device of the golfer 410 that has been approved by the tournament server 120. The video stream 320 and/or other video may, for example, be automatically uploaded immediately following the completion of each hole, or after the completion of a round. After a brief delay, the recordings featuring a split-screen view of the golfer 410 in the simulator 110 and the shot tracker may appear at the session control server 118 which can compile a live leaderboard. When using the mobile phone for the recording, the tournament may require, for example, that the golfer 410 positions the phone behind the permitted hitting area 422 so that the golf swing and the permitted hitting area 422 are both visible.

In some embodiments, the golfer 410 may be required to put when on the green and outside a so-called gimme circle defined in the tournament rules (e.g., 2.4 m). When the tournament server 120 receives an indication that a ball is within the gimme circle, the tournament server 120 or the simulator 110, 400, 500 may indicate that the golfer 410 is automatically considered to have completed the hole without actually taking this putt—i.e., the putt is considered to have been made successfully.

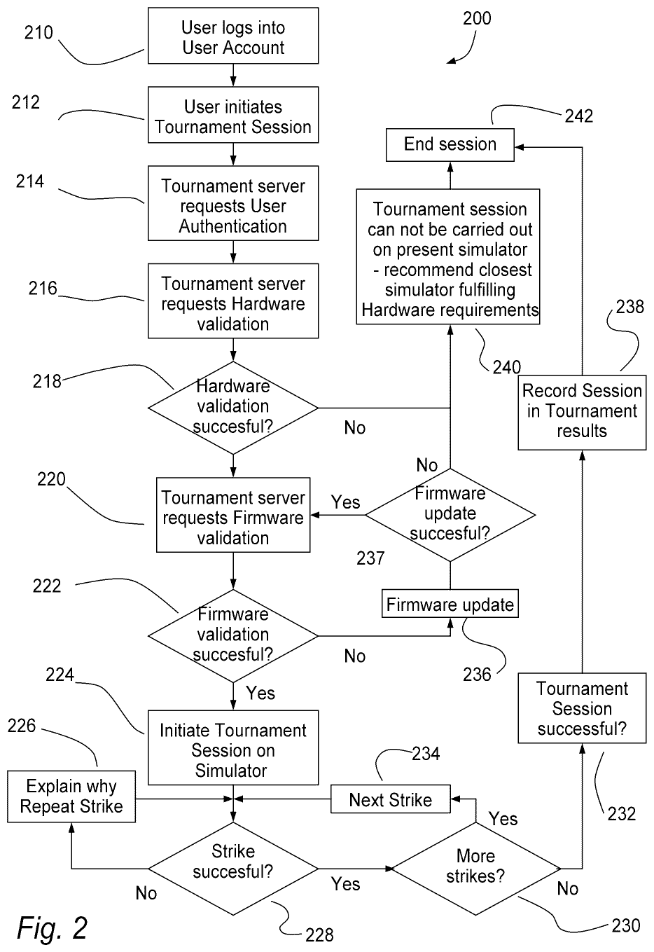

FIG. 2 illustrates a flow chart 200 for steps for ensuring fairness in virtual golf tournament according to the disclosure. The sign-in procedure 310 shown in FIG. 3 is initiated in step 210 where the golfer 410 signs in to the user account server 112 from the simulator 110 via, for example, an encrypted path to minimize the risk that data will be compromised. The identity of the golfer 410 is then authenticated based on the sign-in procedure 310. In step 212, the golfer 410 initiates a tournament session process 312 between the simulator 110 and the tournament server 120 by requesting permission to play in the virtual golf tournament. The tournament server 120 operates as an authorization server, and via the user authentication, determines in step 214 whether the golfer 410 has authorization to play in the virtual golf tournament (i.e., the tournament server 120 verifies that the golfer 410 fulfils the requirements for participation including, for example, having properly signed up and paid the required fees.

When the golfer 410 is authorized to attend the virtual golf tournament according to the disclosure, the tournament server 120 initiates the hardware validation process 314 by requesting, in step 216, that the simulator 110 on which a golfer 410 has initiated a tournament session required data regarding the hardware components of the simulator 110 (in the same manner as would be required for a golfer 410 using the simulator 400 or 500) that is necessary to determine if the simulator 110 meets the tournament requirements. As indicated above, the hardware validation process 314 includes comparing the data of the components of the simulator 110 to data stored in the hardware validation register 114.

In step 218, the tournament server 120 evaluates whether the hardware validation process 314 was successful or not. If the hardware validation process 314 was successful, the tournament server 120 continues and initiates the firmware validation process 316. If unsuccessful, the tournament server 120 jumps to step 240, and communicates to the golfer 410 that he cannot play in the virtual golf tournament using the simulator 110 as the hardware of the simulator 110 does not fulfil the requirements of the virtual golf tournament. The tournament server 120 may, at this point, recommend one or more nearby simulators that have already passed the hardware validation process. The session is then terminated in step 242. The golfer may play virtual golf in the golf simulator, but he is not authorized to attend the virtual golf tournament according to the preset disclosure from the rejected simulator 110.

When the hardware validation process 314 has been successfully completed, the firmware validation process 316 is started in step 220 by the tournament server 120 requesting the simulator 110 to identify data concerning its firmware components. In step 222, the tournament server 120 then checks this data to determine whether the firmware of (e.g., the launch monitor) meets the requirements.

If firmware validation process 316 fails in step 222, the user of this simulator 110 is requested to update the firmware in step 236. If the firmware update in step 236 was successful, the tournament server 120, in step 237, repeats step 220 by again requesting the simulator 110 to identify data concerning its firmware components and repeats step 222, by checking again whether the firmware now meets the requirements specified in the firmware validation register 116. If the firmware has been updated but still does not fulfil the system requirements, the tournament server 120, in step 237, discontinues the firmware validation process 316 and jumps to step 240 in which the tournament server 120 notifies the golfer 410 he cannot play in the virtual golf tournament using the simulator 110 as the firmware of the simulator 110 does not fulfil the requirements of the tournament.

In step 224, after having successfully completed the hardware and firmware validation processes, the golfer 410 may start playing the Virtual Golf Tournament in the tournament session 318. During the tournament session 318, the golfer 410 plays a golf course in, for example, a stroke play game identified by the tournament server 120 and managed by the simulator 110 which tracks each shot and calculates ball trajectory data as is understood by those skilled in the art so that the golfer 410 can play each hole and upload the relevant data to the tournament server 120 after each shot or in any desired timing (e.g., after each completed hole, after each completed round, etc.). In parallel, in this embodiment the simulator 110 forwards to the tournament server 120, the video stream 320 as described above (e.g., over the Internet).

The tournament server 120 forwards the video stream 320 and the calculated ball data to the session control server 118 which verifies (e.g., shot-by-shot) whether this shot has been made in accord with the rules of the tournament. Based on the response from the session control server 118, the tournament server 120 decides in step 228 whether the latest shot was allowable or not. If the shot was found to violate any of the tournament rules, the tournament server 120 communicates this information to the golfer 410 in step 226 and may also communicate the consequences of this determination. As indicated above, possible consequences communicated in step 226 may include that the golfer 410 must re-take the shot, get one or more penalty points added to his score, or become disqualified, or any of a number of other consequences.

When the tournament server 120 decides in step 228 that the latest shot was made in accord with the rules, the tournament server 120 determines in step 230 whether the tournament participation of the golfer 410 has been completed. When the participation of the golfer 410 has not been completed, the tournament server 120 monitors, in step 234, the next shot taken by the golfer 410. The tournament server 120 repeats steps 234 and 228 until all of the holes have been completed by the golfer 410 as decided in step 232. When the tournament server 120 determines that the golfer 410 has completed the tournament, the tournament server 120 forwards the relevant data for the golfer 410 to a tournament result list in the tournament server 120 where this data is recorded in step 238. The session is then terminated in step 242.

1. A system for ensuring fairness in a virtual golf tournament, comprising:
a tournament server configured to manage the virtual golf tournament with multiple golfers playing golf on a plurality of golf simulators, the tournament server has access to a list of permitted hardware configurations for the golf simulators; and
each of the golf simulator configured to allow a playing golfer to play the virtual golf tournament,
wherein the tournament server is configured to permit participation in the virtual golf tournament from a specific golf simulator based on the hardware configuration of the specific golf simulator.

2. The system according to claim 1, wherein the golf simulator and the tournament server initially in a golfer-initiated tournament session runs through a hardware validation process.

3. The system according to claim 2, wherein the tournament server during the hardware validation process requests hardware configuration data from the golf simulator for verification against the list of permitted hardware configurations.

4. The system according to claim 3, wherein the hardware configuration data identifies individual hardware elements of the golf simulator and firmware ensuring interoperability of the individual hardware elements of the golf simulator.

5. The system according to claim 2, wherein the golf simulator comprises at least one launch monitor configured to track a golf ball for determining its launch parameters, and wherein the tournament server is configured to request hardware configuration data for the launch monitor.

6. The system according to claim 5, wherein the launch comprises an imager and/or a radar sensor device, and wherein the tournament server in a firmware validation session is configured to request firmware version data for the launch monitor for verification against the list of permitted hardware configurations.

7. The system according to claim 1, wherein the tournament server is configured to operate as an authorization server authorizing rights of the golfer to play golf in the virtual golf tournament.

8. The system according to claim 1, wherein the tournament server during a tournament session is configured to receive golf data and a video stream from one of the golf simulators, the tournament server is further configured to pass the video stream to a session control server for verifying that the golfer plays according to rules of the virtual golf tournament, and wherein the session control server uses Artificial Intelligence on the video received to detect fraud or misbehavior.

9. The system according to claim 8, further comprising:
a session control server configured to receive a video segment of the golfer playing in a virtual environment,
wherein the session control server being configured to verify that the golfer plays according to the rules of the virtual golf tournament.

10. The system according to claim 9, wherein the session control server is configured to automatically control that each shot in a game play is according to the rules of the virtual golf tournament.

11. The system according to claim 9, wherein the session control server is configured to use Artificial Intelligence on the video received to detect fraud or misbehavior.

12. The system according to claim 9, wherein the session control server comprises at least one sub-program specifically trained for detecting some predefined elements in the received video segment.

13. The system according to claim 12, wherein the sub-program is specifically trained for detecting whether a golf ball is hit from within a permitted hitting area of a hitting mat.

14. The system according to claim 12, wherein the sub-program is specifically trained for visionally recognizing golf clubs used by the golfer.

15. The system according to claim 14, wherein the session control server is configured, based om input from the sub-program is specifically trained for visionally recognizing the golf clubs, to ensure that a number of the golf clubs used in the virtual golf tournament does not exceed a preset limitation.

16. The system according to claim 12, wherein the sub-program is specifically trained to visionally recognize the golfer, and ensure by means of face recognition, bio-mechanical analyses, and clothing recognition to ensure that the golfer playing an entire round.

17. The system according to claim 16,
wherein the tournament server is configured to provide a sign-in procedure authenticating a golfer to sign into the virtual golf tournament and
wherein the session control server is configured, based om input from the sub-program trained to visionally recognize the golfer, to determine that the playing golfer actually is the golfer who has been authenticated in the sign-in procedure.

18. The system according to claim 12, wherein the sub-program is specifically trained to detect that tees are only used for shots from a tee box in a virtual golf software.

19. A method for ensuring fairness in a virtual golf tournament, comprising:
managing the virtual golf tournament with multiple golfers playing virtual golf on a plurality of geographically distributed golf simulators with different hardware configurations;
receiving, in a tournament server, prior to start of a tournament session, data relating to hardware configuration of the golf simulator on which the tournament session is to be played;
comparing the received data relating to the hardware configuration of the golf simulator to a list of permitted hardware configurations for the golf simulators; and
permitting participation in the virtual golf tournament from a specific golf simulator based on the hardware configuration of the specific golf simulator.

20-39. (canceled)

40. One or more processors configured to:
receive data from a plurality of golf simulators including configuration information concerning a hardware configuration and a software configuration of each of the golf simulators;
compare for each of the golf simulators the configuration information to requirement information to determine whether each of the golf simulators complies with requirements for a virtual golf tournament;
receive from each of a plurality of golfers identifying information indicating an identity of the golfer and identifying one of the golf simulators to be used by the golfer;
enter into the virtual golf tournament only a subset of the golfers whose identifying information indicates a golf simulator determined to comply with the requirements for the virtual golf tournament;
during the virtual golf tournament, receive from each of the golf simulators corresponding to one of the golfers entered into the virtual golf tournament, images of a permitted hitting area of the corresponding golf simulator; and
determining using image processing of the images received from the golf simulators corresponding the golfers entered into the virtual golf tournament whether each shot taken by each of the golfers is taken in accord with tournament rules.
